(19) United States
(12) Patent Application Publication
(10) Pub. No.: US 2025/0264682 A1
(43) Pub. Date: Aug. 21, 2025

(54) FANOUT DEVICE FOR MULTICORE FIBER CABLE

(71) Applicant: Chiral Photonics, Inc., Pine Brook, NJ (US)

(72) Inventors: Victor Il'ich Kopp, Fair Lawn, NJ (US); Jing Zhang, Union, NJ (US); Christopher W. Draper, Allendale, NJ (US); Jonathan Singer, New Hope, PA (US); Daniel Neugroschl, Suffern, NY (US)

(21) Appl. No.: 19/058,703

(22) Filed: Feb. 20, 2025

Related U.S. Application Data
(60) Provisional application No. 63/556,285, filed on Feb. 21, 2024.

(51) Int. Cl. G02B 6/44; G02B 6/02; G02B 6/38

(52) U.S. Cl. CPC G02B 6/44715; G02B 6/02042; G02B 6/3885

(57) ABSTRACT

A multicore fiber cable fanout device configured to connect a multicore fiber (MCF) cable comprising M MCFs having N cores with M×N single core fiber (SCP) pigtails is provided. The fanout device can include a housing enclosure and M MCF-to-SCF fanouts within the housing enclosure. The M×N SCF pigtails can be grouped in M×N/K SCF groups containing K SCF pigtails.

### CROSS-REFERENCE TO RELATED APPLICATIONS

This application claims the benefit of priority to U.S. Provisional Application No. 63/556,285 (Attorney Docket No. CHIRA.047PR), entitled “FANOUT DEVICE FOR MULTICORE FIBER CABLE,” filed Feb. 21, 2024, which is incorporated in its entirety by reference herein.

### BACKGROUND

### Field

This disclosure relates generally to optical components such as fanout devices for multicore fiber (MCF) cable.

### Description of the Related Art

A cable fanout can refer to a device that splits the optical fibers from the cable into individual optical fibers. This can include a multicore fiber (MCF) cable, where the fanout splits the cable into individual MCFs. However, for many applications, devices that split an MCF cable to a set of single core fibers can be desirable.

### SUMMARY

Example implementations described herein have innovative features, no single one of which is indispensable or solely responsible for their desirable attributes. Without limiting the scope of the claims, some of the advantageous features will now be summarized.

1. A multicore fiber cable fanout device configured to connect a multicore fiber (MCF) cable comprising M MCFs having N cores with M×N single core fiber (SCF) pigtails, the fanout device comprising:
a housing enclosure; and
M MCF-to-SCF fanouts within the housing enclosure, wherein said M×N SCF pigtails are grouped in M×N/K SCF groups containing K SCF pigtails.

2. The multicore fiber cable fanout device of Example 1, wherein the M×N SCF pigtails are identifiable to corresponding cores of the MCFs.

3. The multicore fiber cable fanout device of Example 1 or 2, further comprising M×N/K furcation tubes, wherein K SCF pigtails of K/N fanouts are grouped together.

4. The multicore fiber cable fanout device of any of Examples 1-3, wherein said M×N SCF pigtails are color-coded in individual ones of said M×N/K SCF groups.

5. The multicore fiber cable fanout device of Example 4, wherein the pigtails are identifiable using the same color-coding for different groups.

6. The multicore fiber cable fanout device of Example 5, wherein the pigtails are identifiable using the same color-coding for each of said groups.

7. The multicore fiber cable fanout device of any of Examples 1-6, wherein 1<M<10000, 1<N<37, and 1<K<48.

8. The multicore fiber cable fanout device of any of Examples 1-7, wherein K=12.

9. The multicore fiber cable fanout device of any of Examples 1-8, wherein 12 SCF pigtails are color-coded with 12 encoding colors from blue to aqua.

10. The multicore fiber cable fanout device of any of Examples 1-9, wherein said housing enclosure encloses MCF-MCF splices.

11. The multicore fiber cable fanout device of any of Examples 1-10, wherein said housing enclosure is a single housing enclosure.

12. A method of connecting a multicore fiber (MCF) cable comprising M MCFs having N cores with M×N single core fiber (SCF) pigtails, the method comprising:
connecting M MCF-to-SCF fanouts to the M MCFs; and
connecting the M MCF-to-SCF fanouts to the M×N SCF pigtails in M×N/K SCF groups containing K SCF pigtails.

13. The method of Example 12, wherein the M×N SCF pigtails are identifiable to corresponding cores of the MCFs.

14. The method of Example 12 or 13, wherein connecting M MCF-to-SCF fanouts to the M MCFs comprises splicing the MCF-to-SCF fanouts to the MCFs.

15. The method of any of Examples 12-14, wherein connecting the M MCF-to-SCF fanouts to the M×N SCF pigtails comprises providing M×N/K furcation tubes, wherein K SCF pigtails of K/N fanouts are grouped together.

16. The method of any of Examples 12-15, wherein said M×N SCF pigtails are color-coded in individual ones of said M×N/K SCF groups.

17. The method of Example 16, wherein the pigtails are identifiable using the same color-coding for different groups.

18. The method of Example 17, wherein the pigtails are identifiable using the same color-coding for each of said groups.

19. The method of any of Examples 12-18, wherein 1<M<10000, 1<N<37, and 1<K<48.

20. The method of any of Examples 12-19, wherein K=12.

### BRIEF DESCRIPTION OF THE DRAWINGS

FIGS. 1A and 1B schematically illustrate an example multicore fiber (MCF) cable fanout device.

FIG. 2 schematically illustrates an example MCF cable fanout device.

FIG. 3 schematically illustrates another example MCF cable fanout device.

FIGS. 4A-4C show example internal components of an MCF cable fanout device.

FIGS. 5A and 5B show example dimensions of an MCF cable fanout device.

FIG. 6 illustrates an example method of connecting an MCF cable with SCF pigtails.

### DETAILED DESCRIPTION

In the present disclosure, a multicore fiber (MCF) cable fanout device can refer to an MCF cable connected to a set of corresponding single core fibers. Since the proper identification of the fiber leads can be useful for the MCF cable application, different ones, possibly each, of the single core fiber (SCF) leads can have one-to-one identification to the corresponding core of the appropriate MCF fiber in the cable. For this identification purpose, in fiber optic cables, optical fibers can be split into groups, either connected to each other or combined (e.g., separately combined), for example, in a tube such as in a furcation tube. In various implementations, the MCF cable fanout device of the present disclosure, can connect a MCF cable composed of M MCFs having N cores in each fiber with M×N SCF pigtails uniquely identified in groups containing K fibers. To achieve this goal, in various embodiments, M MCF-to-SCF fanouts can be placed in a common enclosure and pigtails of a plurality (K/N) of fanouts can be grouped together.

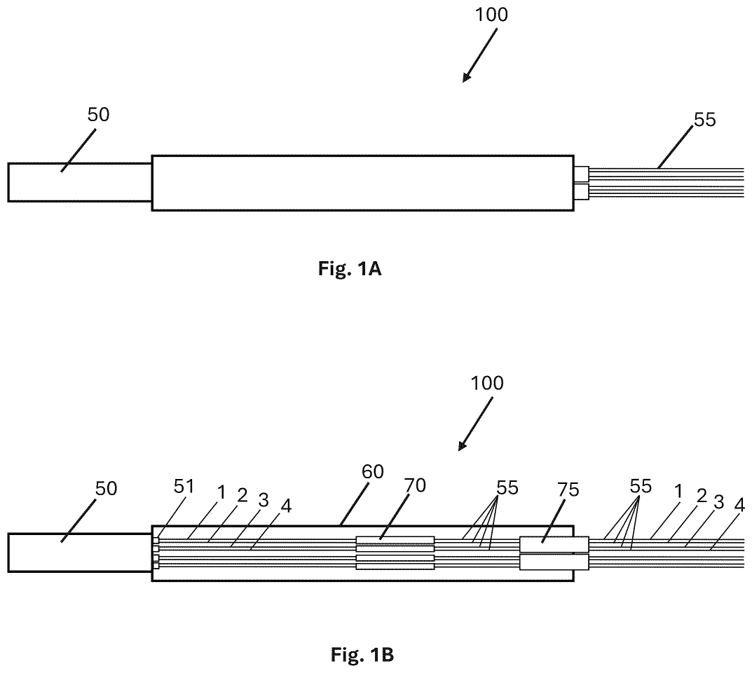

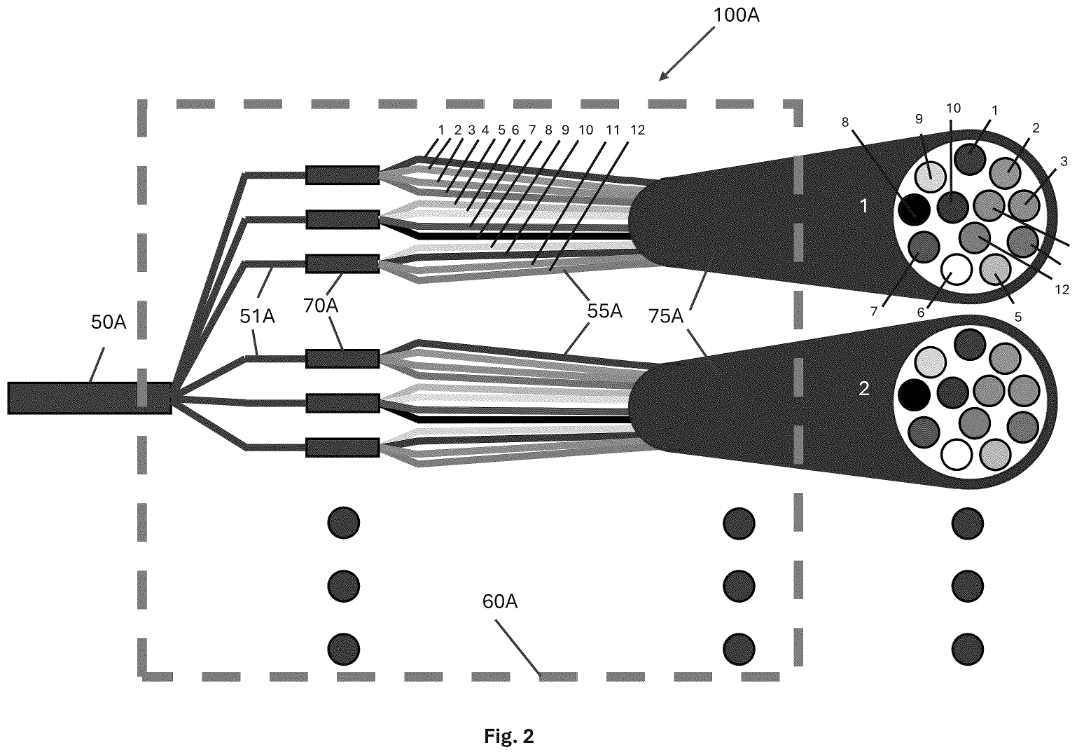

An example MCF cable fanout device 100 is schematically illustrated in FIG. 1A. The MCF cable fanout device 100 can be configured to connect an MCF cable 50 with SCF pigtails 55. FIG. 1B schematically illustrates example internal components within the housing enclosure 60 of the MCF cable fanout device 100. FIG. 1B is illustrated for simplicity and not drawn to scale. As shown in the example, the MCF cable fanout device 100 can include a number of MCF-to-SCF fanouts 70 within the housing enclosure 60 to connect the MCF cable 50 composed of MCFs 51 with SCF pigtails 55 that are be grouped into SCF groups 75. Advantageously, the SCF pigtails 55 within the SCF groups 75 can be identifiable (e.g., 1, 2, 3, 4, etc.) to corresponding cores (e.g., 1, 2, 3, 4, etc.) of the MCFs 51. An example will now be described with respect to FIG. 2.

In the example implementation of an MCF cable fanout device 100A illustrated in FIG. 2, the MCF cable 50A can include M MCFs 51A having N cores, wherein M represents the number of MCFs 51A and N represents the number of cores in individual ones of the MCFs 51A. The MCF cable fanout device 100A can include M MCF-to-SCF fanouts 70A within the housing enclosure 60A to connect the M MCFs 51A with the SCF pigtails 55A. The number of SCF pigtails 55A can include M×N SCF pigtails 55A, and the M×N SCF pigtails 55A can be grouped in M×N/K SCF groups 75A containing K SCFs 55A, where K represents the number of SCFs 55A in individual groups 75A. In FIG. 2, SCF pigtails 55A of K/N fanouts 70A are grouped together.

An example number M of MCFs 51A can range from between 1 and 10000 (for example, 1<M<10000). However, the number M of MCFs 51A within an MCF cable 50A is not particularly limited, and other examples are possible. The number N of cores in individual ones of the MCFs 51A is also not particularly limited. An example number N of cores in individual ones of the MCFs 51A can range from between 1 and 37 (for example, 1<N<37). However, other examples, such as with a larger number of cores, are possible. In addition, the number of SCFs 55A in individual groups 75A can range between 1 and 48 (for example, 1<K<48). However, other examples, such as with a larger number of SCFs 55, are possible. Other examples, with other geometries and/or numbers of MCFs 51, cores, fanouts 70, SCFs 55, groups 75, or any combination of these, are possible.

For illustration purposes, the example MCF cable 50A in FIG. 2 can include 144 MCFs 51A having 4 cores (for example, M=144 and N=4). For simplicity, FIG. 2 only shows 6 of 144 MCFs 51A. The MCF cable fanout device 100A can include 144 MCF-to-SCF fanouts 70A (for example, M=144) to couple the 144 MCFs 51A of the MCF cable 50A with the SCF pigtails 55. For simplicity, only 6 of 144 MCF-to-SCF fanouts 70A are shown. The 576 SCF pigtails 55A (for example, M×N=144×4=576) are grouped in 48 SCF groups 75A (for example, M×N/K=144×4/12=48) containing 12 SCFs 55A (for example, K=12) in individual groups 75A. For simplicity, only 24 of the 576 SCF pigtails and 2 of the 48 SCF groups 75A are shown. In FIG. 2, the SCF pigtails 55A of 3 fanouts 70A (for example, K/N=12/4=3) are grouped together. As described, the SCF pigtails 55A in individual groups 75A can be connected to each other or combined (e.g., separately combined), for example, in a tube such as in a furcation tube. In various examples, the number of furcation tubes can be equal to or less than the number of SCF groups 75A (for example, can be equal to or less than M×N/K=48).

In this example implementation, the number of SCFs in a group can be 12. Inside the group, fibers can be identified by a fiber identifier such as by a color from blue to aqua, and/or the fiber groups can be identified by a group identified such as, for example, by a number printed either directly on the connected fiber group or on the furcation tube. In some cases, the color identifiers may comprise standard colors. For example, the color coding can follow Telecommunications Industry Association's TIA-598-C Optical Fiber Cable Color Coding. For instance, 12 SCFs can be color coded with 12 encoding colors from blue to aqua (for example, blue, orange, green, brown, slate/gray, white, red, black, yellow, violet, rose/pink, and aqua/light blue). The M×N SCF pigtails can be color-coded in individual ones of the M×N/K SCF groups. The pigtails can be identifiable using the same color-coding for different groups. In some instances, the pigtails can be identifiable using the same color-coding for each of the groups.

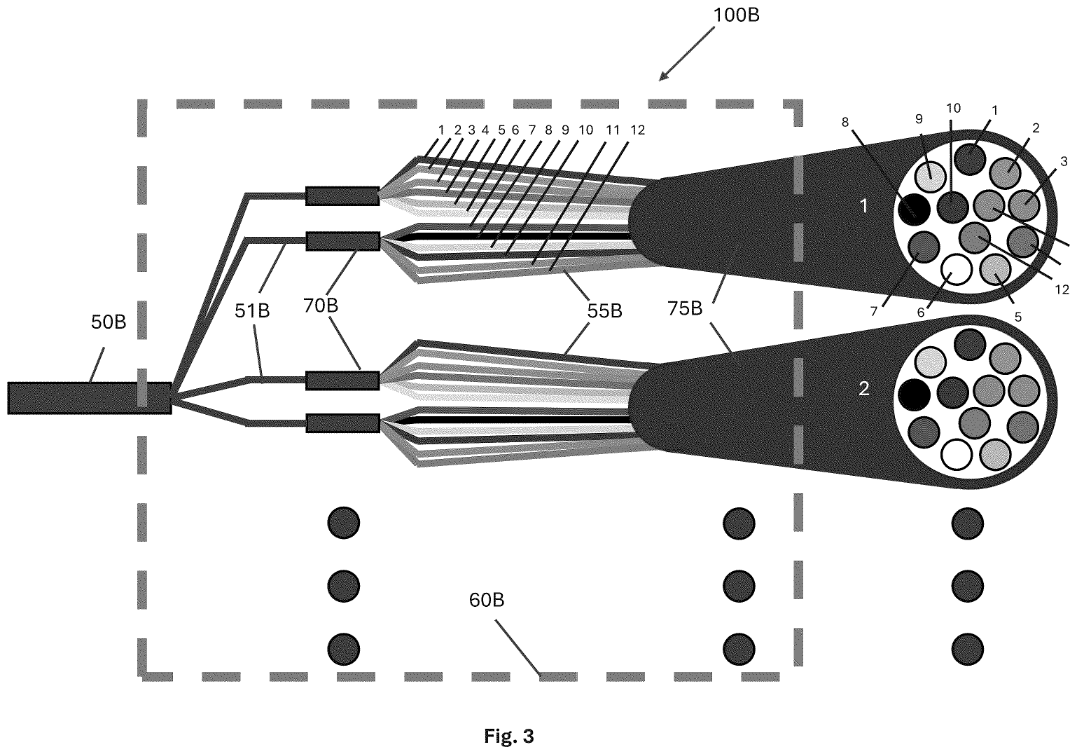

FIG. 3 is another example implementation using 96 MCF-to-SCF fanouts 70B for 96 6-core MCFs 51B instead of 144 MCF-to-SCF fanouts 70A for 144 4-core MCFs 51A used in FIG. 2. The example shown in FIG. 3 can be used for a same 576-channel link as in FIG. 2 (for example, M×N=96×6=576 SCF pigtails 55B). For simplicity, FIG. 3 only shows 4 of 96 MCFs 51B and only 4 of 96 MCF-to-SCF fanouts 70B. The 576 SCF pigtails 55B are grouped in 48 SCF groups 75B (for example, M×N/K=96×6/12=48) containing 12 SCFs 55B (for example, K=12) in individual groups 75B. For simplicity, only 24 of the 576 SCF pigtails and 2 of the 48 SCF groups 75B are shown. In FIG. 3, the SCF pigtails 55B of 2 fanouts 70B (for example, K/N=12/6=2) are grouped together. Other examples are possible.

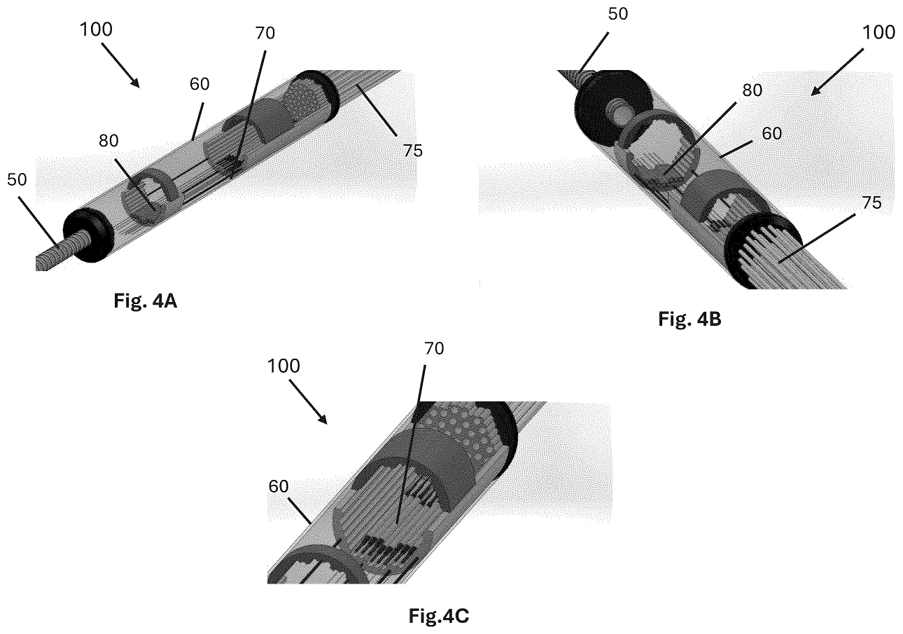

FIGS. 4A-4C show example internal components of an MCF cable fanout device 100. The MCF-to-SCF fanout 70 placement inside the housing enclosure 60 may be parallel, forming a close-packed arrangement, as shown in FIGS. 4A-4C, or it may be in other parallel and/or serial configurations or other configurations. FIGS. 4A-4C correspond to the example shown in FIG. 2. For example, FIGS. 4A-4C show an MCF cable fanout device 100 for an MCF cable 50 with M=144 MCFs, each having N=4 fibers. The MCF cable fanout device 100 has 144 MCF-to-SCF fanouts 70 with M×N=576 SCF pigtails grouped in the M×N/K=48 groups 75 of K=12 SCFs in each group 75. A small number of fanouts 70 is shown for easier visibility and SCF groups 75 are represented by the 48 tubes 75 in FIGS. 4A-4C.

The MCF-to-SCF fanouts 70, shown as tubes may be fabricated directly with the MCFs of the cable 50 or may be fabricated separately and fusion-spliced to the MCFs of the cable 50. As an example, MCF-MCF splice-protection tubes 80 are enclosed in the housing 60 as shown in FIGS. 4A-4C. The fanouts 70 can be made, for example, of silica glass and/or packaged in small tubes such as metal tubes, e.g., stainless steel tubes. The MCF-MCF splice-protection tubes 80 can be made of an inside meltable plastic tube, an outside shrink tube, and a metal pin in-between. In various instances there are M splice-protection tubes 80 (for example, M splice-protection tubes 80 protecting M splices between M MCFs and M MCF-to-SCF fanouts). As described, the SCF pigtails 55 in individual groups 75 can be connected to each other or combined (e.g., separately combined), for example, in a tube such as in a furcation tube. In some implementations, the furcation tubes can be made of a thermoplastic polyester elastomer, e.g., a Hytrel® furcation tube.

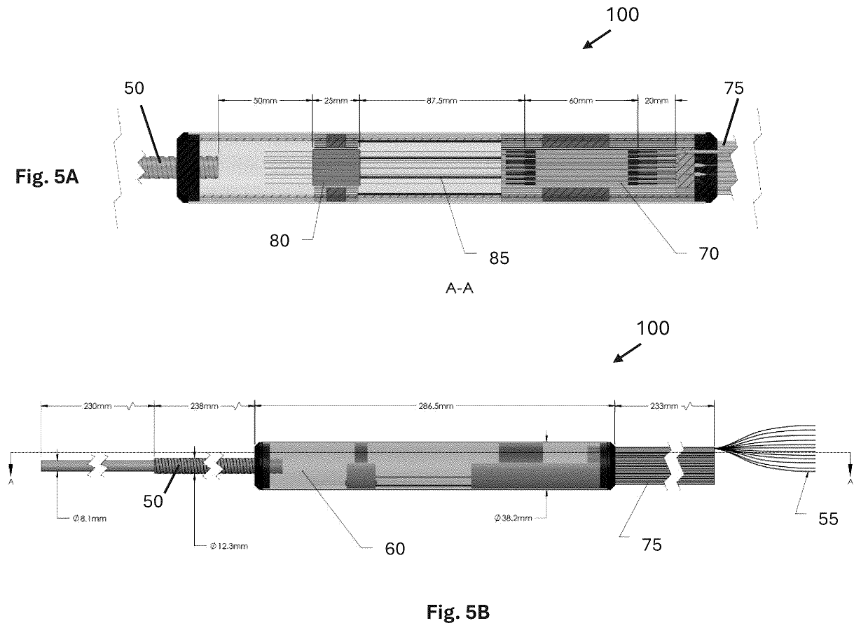

Example dimensions of a 144f-MCF cable fanout device 100 are shown in FIGS. 5A and 5B. In certain advantageous designs, the dimensions can be such that the cable fanout device 100 is compact for practical applications. Other dimensions are possible. In various implementations, the housing enclosure 60 can be a single housing enclosure. The housing can be made of any material, for example, one or more metals and/or one or more polymers. In some implementations, the housing enclosure 60 can comprise a tube, for example, a metal tube or a polymer tube. The housing enclosure 60 can contain the MCF-MCF splices and/or splice protectors 80 and MCF-to-SCF fanouts 70 (e.g., 144 MCF-MCF splices and/or splice protectors 80 and 144 MCF-to-SCF fanouts 70). Spacer rods or other material 85 can be used to help space the SCFs. In various instances, on one side, the MCF cable 50 can be enclosed within an armored cable. On the other side, numbered furcation tubes 75 each containing SCFs can exit the housing enclosure 60 in this example. In this example, there are 48 numbered furcation tubes 75 each containing 12 SCFs. Only 12 of the 576 SCFs are shown for simplicity.

For increased compatibility with existing fiber networks, the SCF pigtails 55 may be part of fiber ribbons, ribbonized, or spliced to fiber ribbons. In some implementations, the number of fibers in the ribbon may be the same as K, the number of SCFs 55 in a group 75. In some implementations, SCF to ribbon splices may be enclosed by the same common enclosure 60, which may be longer to include SCF-ribbon splice protectors. In this case, the housing enclosure 60 can be modified such that only the SCF ribbons may be exiting the common enclosure 60. The common enclosure 60 and enclosure's endcaps may be color-coded (or labeled) to differentiate between right or left cable ends, also known as a polarity of an MCF cable 50. For example, a red enclosure or red end caps may identify a cable's right end and the blue color may indicate a left end. Also, the fanouts 70 themselves may be color-coded or numbered to indicate the order of the fanouts 70 in a group 75.

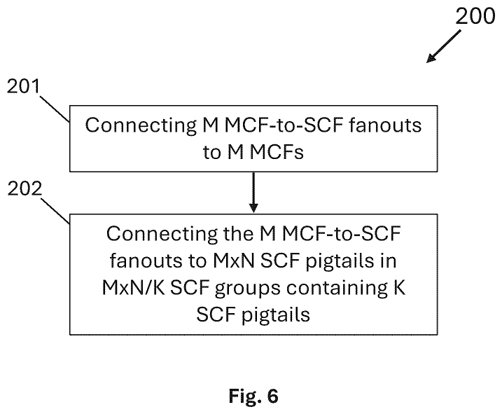

FIG. 6 illustrates an example method of connecting an MCF cable comprising M MCFs having N cores with M×N SCF pigtails. In various implementations, the method can use any of the embodiments of an MCF cable fanout 100 described herein. With reference to FIG. 6, as shown in block 201, the method 200 can include connecting M MCF-to-SCF fanouts to the M MCFs. In some instances, connecting M MCF-to-SCF fanouts to the M MCFs can include splicing the MCF-to-SCF fanouts to the MCFs.

As shown in block 202, the method 200 can also include connecting the M MCF-to-SCF fanouts to the M×N SCF pigtails in M×N/K SCF groups containing K SCF pigtails. In some implementations, the method 200 includes combining the SCF into separate groups. For example, in some implementations, connecting the M MCF-to-SCF fanouts to the M×N SCF pigtails can comprise providing M×N/K tubes such as furcation tubes, in which K SCF pigtails of K/N fanouts are grouped together.

As described herein, the M×N SCF pigtails can be identifiable to corresponding cores of the MCFs. As an example, the M×N SCF pigtails can be color-coded in individual ones of the M×N/K SCF groups. For instance, the pigtails can be identifiable using the same color-coding for different groups. In some cases, the pigtails can be identifiable using the same color-coding for each of the groups. In various designs, 1<M<10000, 1<N<37, and 1<K<48. As an example, K=12. Other examples, such as with other geometries and/or numbers of MCFs 51, cores, fanouts 70, SCFs 55, groups 75, or any combination of these or other components or features, are possible.

### Other Examples

1. Multicore fiber cable fanout to connect a multicore fiber cable composed of M MCFs having N cores fibers with M×N uniquely identified single fiber core pigtails and comprising M MCF-to-SCF fanouts enclosed in a single housing enclosure, where said M×N SCF pigtails are grouped in M×N/K SCF groups containing K SCFs.

2. Multicore fiber cable fanout of Example 1 further comprising of M×N/K furcation tubes, in which pigtails of K/N fanouts are grouped together.

3. Multicore fiber cable fanout of Example 1 where said M×N SCF pigtails are color-coded in each of said M×N/K SCF groups.

4. Multicore fiber cable fanout of Example 1 in which 1<M<10000, 1<N<37, and 1<K<48.

5. Multicore fiber cable fanout of Example 2 where K=12.

6. Multicore fiber cable fanout of Examples 3 and 5 where 12 SCFs are color-coded with a standard 12 encoding colors from blue to aqua.

7. Multicore fiber cable fanout of Example 1 in which said single housing enclosure encloses MCF-MCF splices.

8. A multicore fiber cable fanout configured to connect a multicore fiber (MCF) cable with M MCFs having N cores with M×N single fiber core (SCF) pigtails, the fanout comprising:
a housing enclosure; and
M MCF-to-SCF fanouts within the housing enclosure,
wherein said M×N SCF pigtails are grouped in M×N/K SCF groups containing K SCFs.

9. The multicore fiber cable fanout of Example 8 wherein the M×N SCF pigtails are identifiable to corresponding cores of the MCFs.

10. The multicore fiber cable fanout of Example 8 or 9, further comprising of M×N/K furcation tubes, in which pigtails of K/N fanouts are grouped together.

11. The multicore fiber cable fanout of any of Examples 8-10, wherein said M×N SCF pigtails are color-coded in each of said M×N/K SCF groups.

12. The multicore fiber cable fanout of Example 11, wherein the pigtails are identifiable using the same color-coding for different groups.

13. The multicore fiber cable fanout of Example 12, wherein the pigtails are identifiable using the same color-coding for each of said groups.

14. The multicore fiber cable fanout of any of Examples 8-13, wherein 1<M<10000, 1<N<37, and 1<K<48.

15. The multicore fiber cable fanout of any of Examples 8-14, wherein K=12.

16. The multicore fiber cable fanout of any of Examples 8-15, wherein 12 SCFs are color-coded with 12 encoding colors from blue to aqua.

17. The multicore fiber cable fanout of any of Examples 8-16, wherein said housing enclosure encloses MCF-MCF splices.

18. The multicore fiber cable fanout of any of Examples 8-17, wherein said housing enclosure is a single housing enclosure.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

What is claimed is:

1. A multicore fiber cable fanout device configured to connect a multicore fiber (MCF) cable comprising M MCFs having N cores with M×N single core fiber (SCF) pigtails, the fanout device comprising:
a housing enclosure; and
M MCF-to-SCF fanouts within the housing enclosure, wherein said M×N SCF pigtails are grouped in M×N/K SCF groups containing K SCF pigtails.

2. The multicore fiber cable fanout device of claim 1, wherein the M×N SCF pigtails are identifiable to corresponding cores of the MCFs.

3. The multicore fiber cable fanout device of claim 1, further comprising M×N/K furcation tubes, wherein K SCF pigtails of K/N fanouts are grouped together.

4. The multicore fiber cable fanout device of claim 1, wherein said M×N SCF pigtails are color-coded in individual ones of said M×N/K SCF groups.

5. The multicore fiber cable fanout device of claim 4, wherein the pigtails are identifiable using the same color-coding for different groups.

6. The multicore fiber cable fanout device of claim 5, wherein the pigtails are identifiable using the same color-coding for each of said groups.

7. The multicore fiber cable fanout device of claim 1, wherein 1<M<10000, 1<N<37, and 1<K<48.

8. The multicore fiber cable fanout device of claim 1, wherein K=12.

9. The multicore fiber cable fanout device of claim 1, wherein 12 SCF pigtails are color-coded with 12 encoding colors from blue to aqua.

10. The multicore fiber cable fanout device of claim 1, wherein said housing enclosure encloses MCF-MCF splices.

11. The multicore fiber cable fanout device of claim 1, wherein said housing enclosure is a single housing enclosure.

12. A method of connecting a multicore fiber (MCF) cable comprising M MCFs having N cores with M×N single core fiber (SCF) pigtails, the method comprising:
connecting M MCF-to-SCF fanouts to the M MCFs; and
connecting the M MCF-to-SCF fanouts to the M×N SCF pigtails in M×N/K SCF groups containing K SCF pigtails.

13. The method of claim 12, wherein the M×N SCF pigtails are identifiable to corresponding cores of the MCFs.

14. The method of claim 12, wherein connecting M MCF-to-SCF fanouts to the M MCFs comprises splicing the MCF-to-SCF fanouts to the MCFs.

15. The method of claim 12, wherein connecting the M MCF-to-SCF fanouts to the M×N SCF pigtails comprises providing M×N/K furcation tubes, wherein K SCF pigtails of K/N fanouts are grouped together.

16. The method of claim 12, wherein said M×N SCF pigtails are color-coded in individual ones of said M×N/K SCF groups.

17. The method of claim 16, wherein the pigtails are identifiable using the same color-coding for different groups.

18. The method of claim 17, wherein the pigtails are identifiable using the same color-coding for each of said groups.

19. The method of claim 12, wherein 1<M<10000, 1<N<37, and 1<K<48.

20. The method of claim 12, wherein K=12.
